(19) United States
(12) Patent Application Publication
(10) Pub. No.: US 2019/0169512 A1
(43) Pub. Date: Jun. 6, 2019

(54) METHOD FOR DETERMINING ASPHALTENE STABILITY OF A HYDROCARBON-CONTAINING MATERIAL

(71) Applicant: Chevron U.S.A. Inc., San Ramon, CA (US)

(72) Inventors: Estrella Rogel, Orinda, CA (US); Cesar Ovalles, Walnut Creek, CA (US); Michael E. Moir, San Rafael, CA (US)

(21) Appl. No.: 16/272,725

(22) Filed: Feb. 11, 2019

Related U.S. Application Data
(63) Continuation of application No. 12/833,814, filed on Jul. 9, 2010.
(60) Provisional application No. 61/242,280, filed on Sep. 14, 2009.
(60) Provisional application No. 61/312,765, filed on Mar. 11, 2010.

(51) Int. Cl. C10G 75/00; G06Q 99/00

(52) U.S. Cl. CPC C10G 75/00; G01N 2030/8854; G06Q 99/00

(57) ABSTRACT

A method for determining asphaltene stability in a hydrocarbon-containing material having solvated asphaltenes therein is disclosed. The method involves the steps of: (a) precipitating an amount of the asphaltenes from a liquid sample of the hydrocarbon-containing material with an alkane mobile phase solvent in a column; (b) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent; (c) monitoring the concentration of eluted fractions from the column; (d) creating a solubility profile of the dissolved asphaltenes in the hydrocarbon-containing material; and (e) determining one or more asphaltene stability parameters of the hydrocarbon-containing material.

### BACKGROUND OF THE INVENTION

### 1. Technical Field

The present invention generally relates to a method for determining asphaltene stability in a hydrocarbon-containing material.

### 2. Description of the Related Art

Hydrocarbon materials, such as heavy oils, petroleum residua, coal tars, shale oils, asphalts, or the like can comprise polar core materials, such as asphaltenes, dispersed in lower polarity solvent(s). Intermediate polarity material(s), usually referred to as resin(s), can associate with the polar core materials to maintain a homogeneous mixture of the components.

Refinery processes, including but not limited to, atmospheric or vacuum distillation, visbreaking, hydrocracking, delayed coking, Fluid Coking, Flexicoking, hydrotreatment, delay coker or Eureka process that convert hydrocarbon materials to lighter distillate fuels that require heating for distillation, hydrogen addition, or carbon rejection (coking). However, when using conventional refinery processes, the efficiency of converting such hydrocarbon material may be limited by transition of the hydrocarbon material of homogeneous mixture to a hydrocarbon material of heterogeneous mixture. The transition to the heterogeneous mixture may include the formation of insoluble carbon-rich deposits, including the formation of coke or coke-containing materials. As such, any reduction in carbon deposition, or increase in the distillation yield during the thermal processing of hydrocarbon material can have a significant impact on the manner or economics of hydrocarbon processing.

Asphaltenes are organic heterocyclic macromolecules which occur in crude oils. Under normal reservoir conditions, asphaltenes are usually stabilized in the crude oil by maltenes and resins that are chemically compatible with asphaltenes, but that have lower molecular weight. Polar regions of the maltenes and resins surround the asphaltene while non-polar regions are attracted to the oil phase. Thus, these molecules act as surfactants and result in stabilizing the asphaltenes in the crude. However, changes in pressure, temperature or concentration of the crude oil can alter the stability of the dispersion and increase the tendency of the asphaltenes to agglomerate into larger particles. As these asphaltene agglomerates grow, so does their tendency to precipitate out of solution.

One of the problems encountered in crude oil production and refining is asphaltene precipitation. Generally, unwanted asphaltene precipitation is a concern to the petroleum industry due to, for example, plugging of an oil well or pipeline as well as stopping or decreasing oil production. Also, in downstream applications, asphaltenes are believed to be the source of coke during thermal upgrading processes thereby reducing and limiting yield of residue conversion. In catalytic upgrading processes, asphaltenes can contribute to catalyst poisoning by coke and metal deposition thereby limiting the activity of the catalyst.

Asphaltenes can also cause fouling in, for example, heat exchangers and other equipment in a refinery. Fouling in heat transfer equipment used for streams of petroleum origin can result from a number of mechanisms including chemical reactions, corrosion and the deposit of materials made insoluble by the temperature difference between the fluid and heat exchange wall. The presence of insoluble contaminants may exacerbate the problem: blends of a low-sulfur, low asphaltene (LSLA) crude oil and a high-sulfur, high asphaltene (HSHA) crude, for example, may be subject to a significant increase in fouling in the presence of iron oxide (rust) particulates. Subsequent exposure of the precipitated asphaltenes over time to the high temperatures then causes formation of coke as a result of thermal degradation.

Equipment fouling is costly to petroleum refineries and other plants in terms of lost efficiencies, lost throughput, and additional energy consumption, and, with the increased cost of energy, heat exchanger fouling has a greater impact on process profitability. Higher operating costs also accrue from the cleaning required to remove fouling. While many types of refinery equipment are affected by fouling, cost estimates have shown that the majority of profit losses occur due to the fouling of whole crude oils, blends and fractions in pre-heat train exchangers.

Fouling is generally defined as the accumulation of unwanted materials on the surfaces of processing equipment. In petroleum processing, fouling is the accumulation of unwanted hydrocarbon-based deposits on, for example, heat exchanger surfaces. It has been recognized as a nearly universal problem in design and operation of refining and petrochemical processing systems, and affects the operation of equipment in two ways. First, the fouling layer has a low thermal conductivity. This increases the resistance to heat transfer and reduces the effectiveness of the heat exchangers. Second, as deposition occurs, the cross-sectional area is reduced, which causes an increase in pressure drop across the apparatus and creates inefficient pressure and flow in the heat exchanger.

One of the more common causes of rapid fouling, in particular, is the formation of coke that occurs when crude oil asphaltenes are overexposed to heater tube surface temperatures. The liquids on the other side of the exchanger are much hotter than the whole crude oils and result in relatively high surface or skin temperatures. Certain asphaltenes can precipitate from the oil and adhere to these hot surfaces. Another common cause of rapid fouling is attributed to the presence of salts and particulates. Salts/particulates can precipitate from the crude oils and adhere to the hot surfaces of the heat exchanger. Inorganic contaminants play both an initiating and promoting role in the fouling of whole crude oils and blends. Iron oxide, iron sulfide, calcium carbonate, silica, sodium and calcium chlorides have all been found to be attached directly to the surface of fouled heater rods and throughout the coke deposit.

The cleaning process, whether chemical or mechanical, in petroleum refineries and petrochemical plants often causes costly shutdowns. A majority of refineries practice off-line cleaning of heat exchanger tube bundles based on scheduled time or usage or on actual monitored fouling conditions. Reduction in the extent of fouling will lead to increased run lengths, improved performance and energy efficiency while also reducing the need for costly fouling mitigation options.

In addition, oil refining gives rise to dark heavy high-boiling oil fractions and their mixtures, of which bitumen and heavy fuel oil are made, among other things. The use and storability of these oil raffinates are impaired by the poor solubility or precipitation of asphaltenes in the oil. Thus, susceptibility of the asphaltene components to precipitate determines the stability or storability of the oil, and this depends both on the oil production process used and on the raw materials.

It would be desirable to provide improved methods for determining asphaltene stability in a hydrocarbon-containing material that can be carried out in a simple, cost efficient and repeatable manner.

### SUMMARY OF THE INVENTION

In accordance with one embodiment of the present invention, there is provided a method for determining asphaltene stability in a hydrocarbon-containing material having solvated asphaltenes therein, the method comprising the steps of:

(a) precipitating an amount of the asphaltenes from a liquid sample of the hydrocarbon-containing material with an alkane mobile phase solvent in a column;

(b) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;

(c) monitoring the concentration of eluted fractions from the column;

(d) creating a solubility profile of the dissolved asphaltenes in the hydrocarbon-containing material; and

(e) determining one or more asphaltene stability parameters of the hydrocarbon-containing material.

In accordance with a second embodiment of the present invention, there is provided a method for reducing fouling in one or more crude hydrocarbon refinery components located within a refinery, the method comprising:

(a) selecting one or more hydrocarbon-containing feedstocks having a stable plurality of asphaltene components therein, wherein the selection of the one or more hydrocarbon-containing feedstocks comprises:
(i) precipitating an amount of asphaltenes from a liquid sample of a hydrocarbon-containing material with an alkane mobile phase solvent in a column;
(ii) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;
(iii) monitoring the concentration of eluted fractions from the column;
(iv) creating a solubility profile of the dissolved asphaltenes in the hydrocarbon-containing material; and
(v) determining one or more asphaltene stability parameters of the hydrocarbon-containing material; and

(b) feeding the selected one or more hydrocarbon-containing feedstocks to one or more crude hydrocarbon refinery components.

In accordance with a third embodiment of the present invention, there is provided a system capable of experiencing fouling conditions associated with particulate or asphaltene fouling, the system comprising: (a) one or more crude oil hydrocarbon components; and (b) one or more hydrocarbon-containing feedstocks having a stable plurality of asphaltene components therein and in fluid communication with the one or more crude hydrocarbon refinery components, wherein the one or more hydrocarbon-containing feedstocks are selected by a process comprising:

(i) precipitating an amount of asphaltenes from a liquid sample of a hydrocarbon-containing material with an alkane mobile phase solvent in a column;

(ii) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;

(iii) monitoring the concentration of eluted fractions from the column;

(iv) creating a solubility profile of the dissolved asphaltenes in the hydrocarbon-containing material; and

(v) determining one or more asphaltene stability parameters of the hydrocarbon-containing material.

In accordance with a fourth embodiment of the present invention, there is provided a method for extending the activity of a supported or unsupported catalyst used in the reaction of one or more hydrocarbon-containing feedstocks, the method comprising:

(a) selecting one or more hydrocarbon-containing feedstocks having a stable plurality of asphaltene components therein, wherein the selection of the one or more hydrocarbon-containing feedstocks comprises:
(i) precipitating an amount of asphaltenes from a liquid sample of a hydrocarbon-containing material with an alkane mobile phase solvent in a column;
(ii) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;
(iii) monitoring the concentration of eluted fractions from the column;
(iv) creating a solubility profile of the dissolved asphaltenes in the hydrocarbon-containing material; and
(v) determining one or more asphaltene stability parameters of the hydrocarbon-containing material; and

(b) contacting the selected one or more hydrocarbon-containing feedstocks with the supported or unsupported catalyst at a reaction temperature in a reaction zone.

The method of the present invention advantageously determines the asphaltene stability of a hydrocarbon-containing material having solvated asphaltenes therein in a simple, cost efficient and repeatable manner. In this way, the hydrocarbon-containing material can be readily characterized to allow for the design and monitoring of processes such as refining and production operations for the hydrocarbon-containing material such as crude oils.

In addition, the method of the present invention allows for the use of a small amount of sample and is faster than traditional titration techniques used to evaluate stability and has the potential to be used in or on-line (i.e., automated). The method can also be used at higher temperatures than conventional techniques, substantially closer to process conditions, and can effectively determine stability for asphaltene concentrations lower than, for example, about 1%.

### BRIEF DESCRIPTION OF THE DRAWINGS

FIG. 1 is a graph showing the asphaltene solubility profiles for both Samples #1 and #2 as response versus time for the asphaltenes.

FIG. 2 is a graph showing the peak fitting of the asphaltene solubility profile of a petroleum sample.

FIG. 3 shows the relationship between the average solubility parameter (SPA) of the hard to dissolve asphaltenes with the peptizability (Pa) of the asphaltenes determined by ASTM 6703.

FIG. 4 is a graph showing the asphaltene solubility profiles for both Samples #3 and #4 as response versus time for the asphaltenes.

FIG. 5 shows the stability parameter ΔPS plotted as a function of the standard stability parameter P value measured by ASTM 6703 for two different set of samples (virgin and processed samples).

### DETAILED DESCRIPTION OF THE PREFERRED EMBODIMENTS

The present invention is directed to a method for determining asphaltene stability in a hydrocarbon-containing material having solvated asphaltenes therein. Generally, the method involves (a) precipitating an amount of the asphaltenes from a liquid sample of the hydrocarbon-containing material with an alkane mobile phase solvent in a column; (b) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent; (c) monitoring the concentration of eluted fractions from the column; (d) creating a solubility profile of the asphaltene in the hydrocarbon-containing material; and (e) determining one or more asphaltene stability parameters of the hydrocarbon containing material.

Generally, the source of the hydrocarbon-containing material sample may be any source wherefrom a hydrocarbon crude may be obtained, produced, or the like. The source may be one or more producing wells in fluid communication with a subterranean oil reservoir. The producing well(s) may be under thermal recovery conditions, or the producing well(s) may be in a heavy oil field where the hydrocarbon crude or oil is being produced from a reservoir having a strong water-drive.

In one embodiment, the hydrocarbon-containing material sample includes any heavy hydrocarbons such as heavy crude oil, heavy hydrocarbons extracted from tar sands, commonly called tar sand bitumen, such as Athabasca tar sand bitumen obtained from Canada, heavy petroleum crude oils such as Venezuelan Orinoco heavy oil belt crudes, Boscan heavy oil, Hamaca crude oil, heavy hydrocarbon fractions obtained from crude petroleum oils, particularly heavy vacuum gas oils, vacuum residuum as well as petroleum tar, tar sands and coal tar. Other examples of heavy hydrocarbon feedstocks which can be used are oil shale, shale, coal liquefaction products and the like.

In another embodiment, the hydrocarbon-containing material sample includes any solid hydrocarbon-containing deposit such as asphaltene solids from, e.g., refinery production preparation or an oil facility.

In another embodiment, the hydrocarbon-containing material sample includes any processed sample such as heavy cycle gas oil (HCGO), LC Fining products, fluid catalytic cracking (FCC) products and the like.

In one embodiment, a liquid sample of a hydrocarbon-containing material having solvated asphaltenes therein is provided. As one skilled in the art will readily understand, it may be necessary to add a solvent to the hydrocarbon-containing material in order for the sample to be sufficiently viscous enough to be passed through the column. Useful solvents include any solvent in which the hydrocarbon-containing material sample is soluble or which is capable of allowing the hydrocarbon-containing material sample to be sufficiently viscous to be passed through the column. Representative examples of such solvents include a chlorinated hydrocarbon solvent, an aromatic hydrocarbon solvent, an ether solvent, an alcohol solvent and the like and mixtures thereof. Suitable chlorinated hydrocarbon solvents include, but are not limited to, dichloromethane, 1,2-dichloroethane, chloroform, carbon tetrachloride and the like and mixtures thereof. Suitable aromatic hydrocarbon solvents include, but are not limited to, benzene, toluene, xylene and the like and mixtures thereof. Suitable ether solvents include tetrahydrofuran, diethylether, dioxane and the like and mixtures of thereof. Suitable alcohol solvents include low molecular weight aliphatic alcohols such as methanol, ethanol, isopropanol and the like and mixtures thereof.

In one embodiment, the sample solution can be prepared from about 10 to about 50 wt. % solution of the hydrocarbon-containing material in the solvent(s).

Initially, at least a portion of the sample solution is injected into a column. Generally, the column will have an inlet and an outlet and can be any type of column which is hollow and permits the flow of an aqueous-type material through the interior of the column. The column can be any size and cross sectional shape, e.g., the column can be circular, square, rectangular, triangular, or any other geometrical shape as long as it is hollow and permits the passing of aqueous-type material. In one embodiment, the column is circular. Furthermore, the column can be of any suitable length and any inner diameter or inner cross-sectional area. In one embodiment, the column can have a diameter of from about 0.25 inches to about 1 inch and a length of from about 50 mm to about 500 mm. One skilled the art could envisage that the column can be any inert filtration device for use the method of the invention.

Any suitable material may be selected for use as the column. For example, the column can be formed of a relatively inert or chemically unreactive material such as glass, stainless steel, polyethylene, polytetrafluoroethylene (PTFE), polyaryletheretherketone, (PEEK) or mixtures of thereof, for example, a PEEK-lined stainless steel column.

The column may be vertical or horizontal or arranged in any suitable way, provided that it can be loaded with the sample solution and that the appropriate solvent(s) can be passed through it. As will be understood by those of ordinary skill in the art, a pump may also be used to increase the flow rate.

In another embodiment, an inert packing material is included within the column. The amount of the inert packing material should not exceed an amount which will prevent the passing of any liquid containing material through the column. The packed column advantageously allows for the use of a relatively small volume of sample solution and solvent(s). Suitable inert packing material includes any material that is inert to asphaltene irreversible adsorption. Examples of such materials include fluorinated polymers such as, for example, polyvinylidene fluoride (PVDF), fluorinated ethylene propylene (FEP), polytetrafluoroethylene (PTFE), silicon carbide, polydivinylbenzene (PDVB) and the like and mixtures thereof.

Once the sample solution has been passed into the column, an alkane mobile phase solvent is then passed through the column. The alkane mobile phase solvent should be passed into the column for a time period sufficient to elute the alkane soluble fraction, commonly known as maltenes or petrolenes, and induce precipitation of the alkane mobile phase insoluble fraction, i.e., the precipitated asphaltenes, from the hydrocarbon-containing material. Generally, once the alkane mobile phase solvent enters the column, the alkane mobile phase solvent dilutes and displaces the solvent in the sample solution, thereby allowing the asphaltenes to substantially precipitate therefrom. The alkane soluble fraction then elutes from the column.

Useful alkane mobile phase solvent(s) can be determined by one skilled in the art. In one embodiment, the alkane mobile phase solvent is n-heptane. However, other alkane mobile phase solvents such as, for example, n-pentane or n-hexane may be used.

Once substantially all of the alkane soluble fraction has eluted, a first amount and a second amount of the precipitated asphaltenes are dissolved by gradually and continuously changing the alkane mobile phase solvent to a final mobile phase solvent having a solubility parameter at least 1 MPa^{0.5} higher than the alkane mobile phase solvent. Generally, the first amount of the precipitated asphaltenes (also referred to as “easy to dissolve asphaltenes”) will have a lower solubility parameter than the second amount of asphaltenes (also referred to as “hard to dissolve asphaltenes”). The term gradually as used herein shall be understood to mean that the alkane mobile phase solvent is incrementally removed from the column over a period of time by continuously adding a final mobile phase solvent having a solubility parameter at least 1 MPa^{0.5} higher than the alkane mobile phase solvent to the column. Generally, gradually and continuously changing from essentially the alkane mobile phase solvent to the final mobile phase solvent can occur during a period of about 5 minutes to about 120 minutes at a flow rate of about 1 mL/min. to about 4 mL/min. In one embodiment, gradually and continuously changing from the alkane mobile phase solvent to the final mobile phase solvent can occur during a period of about 15 minutes to about 30 minutes at a flow rate of about 1 mL/min. to about 4 mL/min.

The first amount of the precipitated asphaltenes are dissolved by gradually and continuously changing the alkane mobile phase solvent to a first final mobile phase solvent having a solubility parameter at least 1 MPa^{0.5} higher than the alkane mobile phase solvent. As one skilled in the art will readily appreciate, the selection of the first final mobile phase solvent will depend on such factors as moving from a low solubility parameter solvent (low solvent power) to a high solubility parameter solvent (high solvent power) using solvents that have the right combination of dispersion, polar and hydrogen bonding forces. For example, a first final mobile phase solvent such as a chlorinated hydrocarbon solvent, e.g., dichloromethane, an ether solvent, an aromatic hydrocarbon solvent or mixtures thereof is gradually and continuously added to the column to sequentially change the alkane mobile phase solvent from 100% alkane mobile phase solvent to 100% first final mobile phase solvent, i.e., the alkane mobile phase solvent is changed to 1% dichloromethane in 99% alkane mobile phase solvent, then to 2% dichloromethane in 98% alkane mobile phase solvent, until the mobile phase solvent in the column is 100% dichloromethane and 0% alkane mobile phase solvent. In this manner, a first amount of the precipitated asphaltenes (i.e., easy to dissolve asphaltenes) will be gradually dissolved and a characteristic elution pattern generated, which is referred to as the asphaltene solubility profile, as discussed hereinbelow.

After the first amount of precipitated asphaltenes has been gradually dissolved, a second or remaining amount of the precipitated asphaltenes (which are not capable of being redissolved in the one or more first final mobile phase solvents) is left in the column. Thus, in order to redissolve the second amount of precipitated asphaltenes, also referred to as hard to dissolve asphaltenes (i.e., higher solubility parameter asphaltenes), it is may be necessary to add one or more second final mobile phase solvents having a solubility parameter at least 1 MPa^{0.5} higher than the first final mobile phase solvent to the column in order to substantially dissolve the remaining amount of the precipitated asphaltenes in the column and generate a characteristic elution pattern of the hydrocarbon-containing material. This can advantageously allow for a more accurate determination of the solubility profile of the various asphaltene components in the hydrocarbon-containing material.

The selection of the second final mobile phase solvent will depend on such factors as moving from a lower solubility parameter solvent (the first final mobile phase solvent) to a higher solubility parameter solvent (the second final mobile phase solvent) using solvents that have the right combination of dispersion, polar and hydrogen bonding forces. A suitable one or more second final mobile phase solvent can readily be determined by one skilled in the art, e.g., a C₁ to C₆ alcohol such as methanol. Accordingly, in one embodiment, methanol is gradually and continuously added to the column to sequentially change the first final mobile phase solvent, e.g., dichloromethane, from 100% dichloromethane to 100% methanol, i.e., dichloromethane is first changed to 1% methanol in 99% dichloromethane, then to 2% methanol in 98% dichloromethane, until the second final mobile phase solvent in the column is 100% methanol and 0% dichloromethane.

The flow rate and time period for gradually and continuously adding the one or more second final mobile phase solvents are substantially the same as for the first final mobile phase solvents.

The asphaltene concentration in the eluted fractions from the column is continuously monitored using, for example, a liquid chromatography detector, and recorded in a manner well known in the art. There are a number of commercially available liquid chromatography detectors that can be used including, e.g., refractive index detectors, mass spectrometry, liquid chromatography/mass spectrometry, NMR spectroscopy, Raman spectroscopy, infrared spectroscopy, fluorescence spectroscopy, UV-Vis spectroscopy, and evaporative light scattering detectors (ELSD); all of which can be used in the method described herein. Other online detectors are known to those skilled in the art. Quantification can then be performed using methods known in the art, e.g., using commercially-available computer programs.

In one preferred embodiment, an evaporative light scattering detector is used as a liquid chromatography detector to monitor each eluting sample's concentration. The operating principle of an evaporative light scattering detector is as follows: the compounds to be analyzed are transported by a mobile phase or a more volatile carrier liquid which is then nebulized and evaporated at a relatively low temperature (being able to be in the order of from about 30 to about 150° C.) so that residual micro-particles alone remain—ideally the compounds to be analyzed—which can be detected by light scattering. In this manner, it is possible to analyze directly effluents which originate from the column under the condition of selecting a mobile phase which is volatile enough to be directly used as a carrier liquid for the evaporative light scattering detector. For example, in the case of the asphaltenes, the result is a curve that represents the solubility parameter distribution of the asphaltenes.

Next, a solubility profile of the asphaltenes in the hydrocarbon-containing material can be created by techniques known in the art. For example, when asphaltenes are quantified using an evaporative light scattering detector, the result is a curve that represents the solubility parameter distribution of the asphaltene in the hydrocarbon-containing material. Since the solubility parameter of a mixture of solvents is given by the volumetric average of the components, it is possible to convert the time scale of the elution to a solubility parameter scale using the following equation:

$$δ = {\sum }_{i = 1}^{n} {φ}_{i} {δ}_{i}$$

wherein δ is the solubility profile of the mixture, ϕᵢ is the volume fraction and δᵢ is the solubility parameter of each of the components, respectively. The volume fraction is the volume fraction of the blend of each solvent and readily determined by the chromatography apparatus. The solubility parameter of a component is either known in the art, e.g., Barton, A. F. M. Handbook of Solubility Parameters and Other Cohesion Parameters; CRC Press Inc.: Boca Raton, Fla., 1983, or can be determined by techniques within the purview of one skilled in the art.

Once a solubility profile of the asphaltenes in the hydrocarbon-containing material has been created, one or more asphaltene stability parameters of the hydrocarbon-containing material can then be determined. For example, one or more parameters can be mathematically calculated based on the solubility profile of the asphaltenes. An asphaltene solubility profile normally shows either two peaks or one peak and one shoulder from the evaporative light scattering detector. The two peaks or peak/shoulder can be separated by numerical methods well known in the art such as, for example, peak deconvolution or peak fitting. The first resolved peak is generally known as an “easy to dissolve asphaltene” peak and is derived from step (d) which dissolved the first amount of precipitated asphaltenes. The second resolved peak or shoulder is generally known as a “hard to dissolve asphaltene” peak and is derived from step (e) which dissolved the second, or remaining amount of precipitated asphaltenes. Examples of parameters related to asphaltene stability that can be calculated include the following.

1. Average solubility parameter of the hard to dissolve asphaltenes (SPA). This is a measurement of how difficult it is to dissolve the material eluted in the second peak or shoulder of the solubility profile (i.e., the hard to dissolve asphaltenes). It is calculated as the mean of the distribution corresponding to the second peak or shoulder obtained by the solubility parameter scale calculation discussed above. The higher the value, the more difficult it is to dissolve the hard to dissolve asphaltenes thereby indicating lower stability.

2. Ratio of hard-to-dissolve asphaltenes/easy to dissolve asphaltenes (i.e., second peak area/first peak area ratio wherein the second peak area and first peak area are derived from the solubility profile). After the separation of the peaks discussed hereinabove with respect to the asphaltene solubility profile, the areas for both peaks are calculated and the ratio between both areas determined. The area under the peaks can be determined using commercially available software packages for qualitative and quantitative analysis that include quantification of peak area and height. Commercially available software packages include, by way of example, GRAMS/AI package provided by Thermo Galactic (Salem, N.H.) and Chemstation® by Agilent Technologies (Santa Clara, Calif.). This ratio indicates whether there is enough transitional material or easy to dissolve asphaltenes (first peak) to keep the hard to dissolve (i.e., highly insoluble) asphaltenes (second peak) in solution. Accordingly, the smaller the ratio, the larger the amount of transitional material or easy to dissolve asphaltenes present in the hydrocarbon-containing material.

Overlapping of hard-to-dissolve asphaltenes to the easy to dissolve asphaltenes. This is a measurement of the compatibility between both species and, therefore, can be used to evaluate stability. After the separation of the peaks discussed hereinabove with respect to the asphaltene solubility profile, the area of both peaks are calculated as well as the overlapping area which corresponds with the area that both peaks share and lie in the same region. Accordingly, a higher value indicates greater stability and, therefore, the asphaltenes are less prone to precipitate.

ΔPS measures the broadness of the solubility profile and it is also related to the stability of the asphaltenes in the hydrocarbon-containing material. This parameter is calculated according to the following equation:

ΔPS=t(75%)−t(25%)

wherein t(75%) and t(25%) represent the time at which 75% and 25% of the asphaltenes in the hydrocarbon-containing material (in terms of area) have eluted, respectively. The ΔPS is calculated based on the cumulative areas of the whole distribution of times or solubility parameters that represent the solubility profile of the asphaltenes in the sample. Accordingly, a higher value indicates lower stability and therefore, asphaltenes are more prone to precipitate.

Once one or more of the parameters related to asphaltene stability have been calculated for a given hydrocarbon-containing material, it is advantageous to rerun the method for a different hydrocarbon-containing material and then compare the results of each sample to determine which of the samples have better asphaltene stability. For example, if a first sample had a larger overlapping area as compared to a second sample, this is indicative that the asphaltenes in the first sample are less prone to precipitate. Thus, the asphaltenes in the first sample would have greater stability than the asphaltenes in the second sample.

The information obtained from the method of the present invention can then be stored in a relational database. For example, a relational database can be electrically connected to a signal data collector comprising a computer microprocessor for system operation and control to collect the data from the various tests over an extended period of time to compile a library therefrom. The database can be used to find optimum combinations for a desired product stream, and can be particularly useful when the desired product stream varies depending on market factors. When the product requirements change, appropriate combinations can be selected to prepare the desired product.

Once the asphaltene stability of one or more hydrocarbon-containing materials has been determined, one or more of the selected hydrocarbon-containing material having a desired asphaltene stability can then be used as a refinery feedstock in one or more crude hydrocarbon refining components within a refinery and subjected to one or more refinery processes. The refinery processes that the one or more of the selected hydrocarbon-containing material can be used in are well known in the art.

The term “crude hydrocarbon refinery component” generally refers to an apparatus or instrumentality of a process to refine crude hydrocarbons, such as an oil refinery process, which is, or may be, susceptible to fouling. Crude hydrocarbon refinery components include, but are not limited to, heat transfer components such as a heat exchanger, a furnace, a crude preheater, a coker preheater, or any other heaters, a FCC slurry bottom, a debutanizer exchanger/tower, other feed/effluent exchangers and furnace air preheaters in refinery facilities, flare compressor components in refinery facilities and steam cracker/reformer tubes in petrochemical facilities. Crude hydrocarbon refinery components can also include other instrumentalities in which heat transfer may take place, such as a fractionation or distillation column, a scrubber, a reactor, a liquid-jacketed tank, a pipestill, a coker and a visbreaker. It is understood that “crude hydrocarbon refinery components,” as used herein, encompass tubes, piping, baffles and other process transport mechanisms that are internal to, at least partially constitute, and/or are in direct fluid communication with, any one of the above-mentioned crude hydrocarbon refinery components.

In one embodiment, representative examples of such crude hydrocarbon refinery components include a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, a storage tank, a visbreaker and the like.

Accordingly, another embodiment of the present invention is directed to a method for reducing fouling in one or more crude hydrocarbon refinery components located within a refinery. In general, the method involves:

(a) selecting one or more hydrocarbon-containing feedstocks having a stable plurality of asphaltene components therein, wherein the selection of the one or more hydrocarbon-containing feedstocks comprises:
(i) precipitating an amount of asphaltenes from a liquid sample of a hydrocarbon-containing material with an alkane mobile phase solvent in a column;
(ii) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;
(iii) monitoring the concentration of eluted fractions from the column;
(iv) creating a solubility profile of the dissolved asphaltenes in the hydrocarbon-containing material; and
(v) determining one or more asphaltene stability parameters of the hydrocarbon-containing material; and

(b) feeding the selected one or more hydrocarbon-containing feedstocks to one or more crude hydrocarbon refinery components.

Another embodiment of the present invention is directed to a method for extending the activity of a supported or unsupported catalyst used in the reaction of one or more hydrocarbon-containing feedstocks employing one or more of the selected hydrocarbon-containing feedstocks having a desired asphaltene stability. In general, the method involves:

(a) selecting one or more hydrocarbon-containing feedstocks having a stable plurality of asphaltene components therein, wherein the selection of the one or more hydrocarbon-containing feedstocks comprises:
(i) precipitating an amount of asphaltenes from a liquid sample of a hydrocarbon-containing material with an alkane mobile phase solvent in a column;
(ii) dissolving a first amount and a second amount of the precipitated asphaltenes by gradually and continuously changing the alkane mobile phase solvent to a final mobile phase solvent having a solubility parameter at least 1 MPa^{0.5} higher than the alkane mobile phase solvent;
(iii) monitoring the concentration of eluted fractions from the column;
(iv) creating a solubility profile of the dissolved asphaltenes in the hydrocarbon-containing material; and
(v) determining one or more asphaltene stability parameters of the hydrocarbon-containing material; and

(b) contacting the selected one or more hydrocarbon-containing feedstocks with the supported or unsupported catalyst at a reaction temperature in a reaction zone.

Suitable catalysts include any known supported or unsupported catalyst used in a refinery process such as Ziegler catalysts, Ziegler-Natta catalysts, chromium catalysts, metallocene catalysts, hydroprocessing catalysts, hydrodesulfurization catalysts and the like. For example, the catalyst can be based on a catalyst support selected from the group consisting of alumina, silica-alumina, silica, titania, and magnesia. The catalytic metals on the surface of the support may consist of, for example, cobalt, nickel, molybdenum, tungsten, palladium, combinations thereof and the like. The reaction temperatures and reaction zones in the reaction of the one or more selected hydrocarbon-containing materials and catalysts are well known in the art. Such reactions as well as suitable catalysts are disclosed in, for example, U.S. Pat. Nos. 4,111,787; 4,192,735; 4,196,072 and 4,592,827, the contents of which are incorporated by reference herein.

The following non-limiting examples are illustrative of the present invention.

### Example 1

Typical Solubility Profile Distributions for Different Materials.

Solutions of two heavy crude oils from Venezuela (Sample #1) and Mexico (Sample #2), respectively, were prepared by dissolving 0.1000 g of the heavy crude oil in 10 mL of methylene chloride. Both solutions were injected into a separate stainless steel column packed with poly(tetrafluoroethylene) (PTFE) using a heptane mobile phase at a flow rate of 4 mL/min. The maltenes (heptane solubles) eluted from the column as the first peak around 2 minutes after the injection. After 10 minutes, a final mobile phase of 90/10 methylene chloride/methanol blend was passed into the column at a flow rate of 4 mL/min. The change of the solvent from heptane to the methylene chloride/methanol blend redissolved a portion of the asphaltenes which started to elute around 12 minutes. After 20 minutes, a final mobile phase of 100% methanol was passed into the column at a flow rate of 4 mL/min.

The concentration of maltenes and asphaltenes were quantified using an Evaporative Light Scattering Detector (ELSD) (Alltech ELSD 2000), which was equipped with a light-scattering photometer by evaporating the solvent and passing the stream containing non-volatile particles (asphaltenes or maltenes) through the light-scattering photometer. The ELSD conditions were the following: drift tube temperature−75° C.; volumetric flow of the solvents was 4.0 mL/min. and 3.5 L/min. of nitrogen as the nebulizing gas. The light scattered by the non-volatile particles was collected and is a measure of the concentration of the solute in the column effluent. For the case of asphaltenes, the measurement of the light scattered, also known as response, represents the solubility characteristics of the asphaltenes present in the sample. The time scale can be converted to a solubility parameter scale using the regular solutions approach (See: Barton, A. F. M., Handbook of Solubility Parameters and other Cohesion Parameters, CRC Press, USA, 1991, p. 63). The curves represent the distribution of solubility parameters in the asphaltenes or solubility profile.

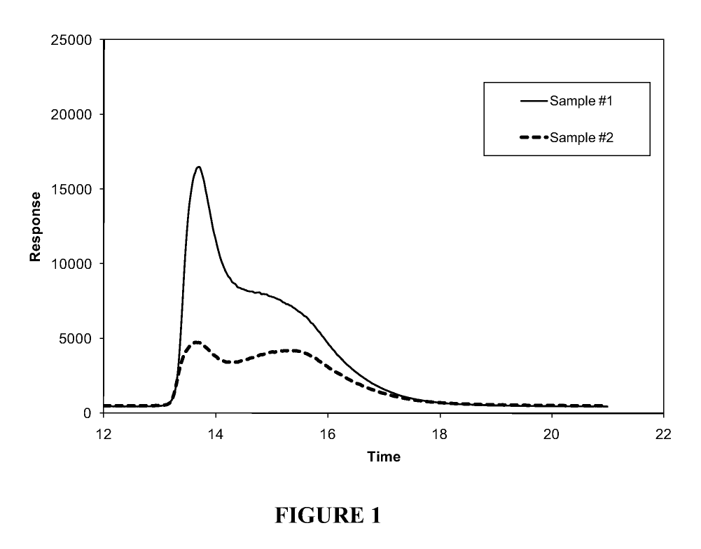

FIG. 1 shows the resulting asphaltene solubility profiles for both Samples #1 and #2 as response versus time for the asphaltenes. This figure indicates the presence of two distinct features in each curve represented by separated peaks (Sample #2) or a peak and a shoulder (Sample #1). In FIG. 1, the first peak for both curves corresponds to “easy to dissolve asphaltenes” and the second peak (or second shoulder) corresponds to “hard to dissolve asphaltenes”. The data in FIG. 1 confirms that asphaltenes from different crude oils exhibit different solubility characteristics and that these differences can be measured using the procedure mentioned above.

### Example 2

Peak Fitting of the Solubility Profile.

A solution of a petroleum product (0.1000 g) was prepared in 10 mL of methylene chloride. The solution was injected into a stainless steel column using the same equipment, solvents and procedure as described in Example 1.

The asphaltene solubility profile of the sample was recorded using the same equipment and in substantially the same manner as in Example 1.

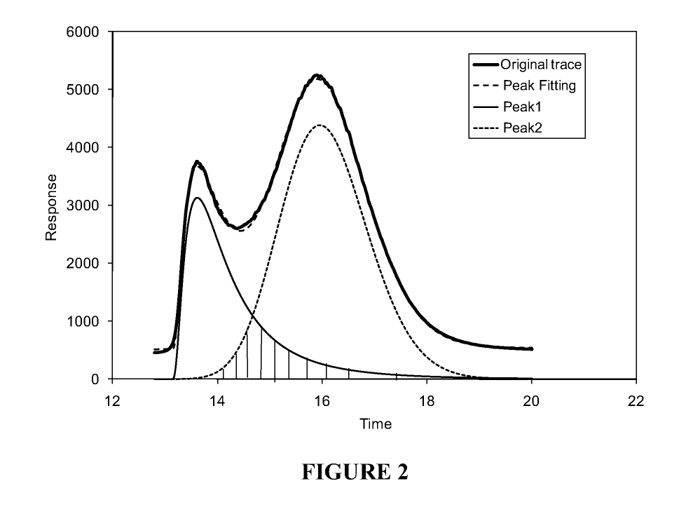

The asphaltene solubility profile shown in FIG. 2 and labeled as original trace was processed mathematically so that it was separated into two distinct peaks (i.e., Peak 1 and Peak 2). A personal computer running commercially available software package (GRAMS/AI by Thermo Galactic) was used for carrying out the mathematical procedure. FIG. 2 also shows the curve corresponding to the peak fitting of the original trace curve as well as the curves corresponding to the separated peaks, i.e., Peak 1 and Peak 2. As discussed in Example 1, Peak 1 is referred to as “easy to dissolve asphaltenes” and Peak 2 is referred to as “hard to dissolve asphaltenes”. The shadow area in the middle of both peaks is called the overlapping area and was calculated using Excel from Microsoft Co. by subtracting both curves and calculating the remaining area using the trapezoidal rule as known in the art. (See: Tuma, J. J., Handbook of Numerical Calculations in Engineering, Mc Graw-Hill Publishing Company, USA, 1989).

The peak fitting was successfully achieved with a correlation coefficient (R²) of 0.9829. This indicates that this procedure is adequate for the separation of the peaks corresponding to easy and hard to dissolve asphaltenes that correlate to stability.

### Example 3

SPA as a Function of the Peptizability Value Determined by ASTM 6703.

Several solutions of asphaltenes extracted from different hydrocarbon containing materials including virgin (Crude oils and vacuum residues) and processed materials were prepared by dissolving 0.0100 g of asphaltenes in 10 mL of methylene chloride. The solutions were injected into a separate stainless steel column using the same equipment, solvents and procedure as described in Example 1.

The asphaltene solubility profile of the sample was recorded using the same equipment and in substantially the same manner as in Example 1. The resulting asphaltene solubility profiles were then mathematically processed according to Example 2 using a personal computer running commercially available software package (GRAMS/AI by Thermo Galactic) to obtain the separated peaks. The SPA or average solubility parameter of the hard to dissolve asphaltenes (Peak 2) was determined as the mean of the distribution of response as a function of time. This value was provided by GRAMS after the successful fitting of the peaks. Once this value was determined, the mean was converted from time units to solubility parameter units using the procedure set forth in Example 1, also known as the regular solution approach.

The stability of the same set of asphaltenes was tested by ASTM 6703 in order to determine Pa, which is the standard way to characterize the solubility characteristics of the asphaltenes (also known as peptizability).

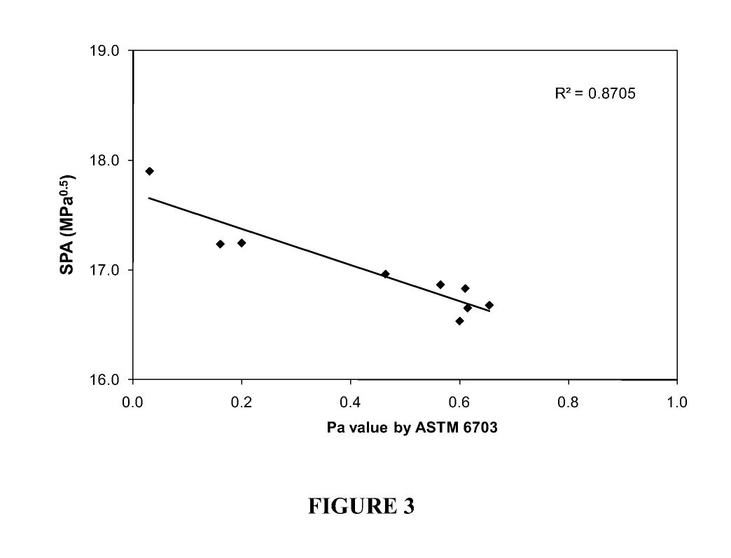

In FIG. 3, the SPA of the hard to dissolve asphaltenes was correlated with the peptizability (Pa) of the asphaltenes determined by ASTM 6703. FIG. 3 shows that low values of Pa (observed for asphaltenes from processed materials) correspond with higher SPA's and, therefore, more hard to dissolve asphaltenes. The higher values of Pa (observed for asphaltenes from virgin materials) correspond with easier to dissolve asphaltenes. By definition, the higher Pa values indicate more stable and less prone to precipitate asphaltenes.

Finally, the correlation coefficient (R²) corroborates that there is a strong correlation between both values (SPA and Pa) and, therefore, they are measuring the same property.

### Example 4

Calculation of Hard to dissolve asphaltenes/Easy to dissolve asphaltenes Ratio and Overlapping of Hard to dissolve asphaltenes to Easy to dissolve asphaltenes.

Solutions of two different hydrocarbon containing materials were prepared by dissolving 0.1000 g of the material in 10 mL of methylene chloride. Sample #3 corresponds to a Medium Crude Oil while Sample #4 corresponds to a hydroprocessed material. Both solutions were injected into a separate stainless steel column using the same equipment, solvents and procedure as described in Example 1.

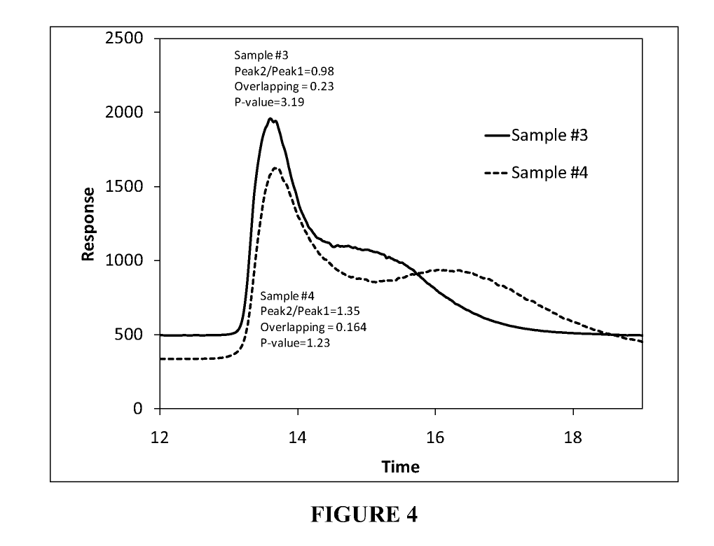

The asphaltene solubility profile of the sample was recorded using the same equipment and in substantially the same manner as in Example 1. FIG. 4 shows the resulting asphaltene solubility profiles for both Samples #3 and #4 as response versus time for the asphaltenes.

The resulting asphaltene solubility profiles shown in FIG. 4 were then mathematically processed according to Example 2 using a personal computer running commercially available software package (GRAMS/AI by Thermo Galactic) to obtain the separated peaks. The area under the two separated peaks was then determined using the GRAMS software package and the overlapping area was calculated using Excel from Microsoft Co. by subtracting both curves and calculating the remaining area using the trapezoidal rule.

In parallel, the stability of Samples #3 and #4 (P-value) was determined by ASTM 6703. A higher P value corresponds to a more stable material.

Next, two parameters were calculated using the values of the areas: Hard to dissolve asphaltenes/Easy to dissolve asphaltenes Ratio, and overlapping of hard to dissolve asphaltenes and easy to dissolve asphaltenes/hard to dissolve asphaltene ratio. The two parameters, namely, hard-to-dissolve asphaltenes/easy to dissolve asphaltenes ratio, and overlapping of hard-to-dissolve asphaltenes to easy-to-dissolve asphaltenes along with the P-value are shown in FIG. 4 for Samples #3 and #4. The hard-to-dissolve asphaltenes/easy to dissolve asphaltenes ratio indicates that Sample #4 contained a relatively larger amount of hard to dissolve asphaltenes as compared to Sample #3. Also, Sample #3 had a larger overlapping area as compared to Sample #4, which indicates better compatibility between the easy and hard to dissolve asphaltenes in Sample #3 than in Sample #4. Both parameters therefore indicate that Sample #3 is more stable than Sample #4. Finally, Sample #3 had a higher P value than Sample #4, which is indicates that Sample #3 is more stable than Sample #4 in terms of asphaltene precipitation.

This example shows that hard to dissolve asphaltenes/easy to dissolve asphaltenes ratio and overlapping of hard to dissolve asphaltenes to easy to dissolve asphaltenes can be used to estimate asphaltene tendency to precipitate.

### Example 5

ΔPS as a Function of the P Value of the Samples Measured by ASTM 6703.

Solutions of several hydrocarbon-containing materials including virgin (crude oil) oil and processed materials (hydroprocessed and thermal processed materials) were prepared by dissolving 0.1000 g of the material in 10 mL of methylene chloride. The solutions were injected into a separate stainless steel column using the same equipment, solvents and procedure as described in Example 1.

The asphaltene solubility profile of each sample was recorded using the same equipment and in substantially the same manner as in Example 1. The resulting asphaltene solubility profiles were mathematically processed to obtain ΔPS. The ΔPS was calculated based on the cumulative areas of the whole distribution that represented the solubility profile of the asphaltenes in the sample. The cumulative areas were calculated using Excel by Microsoft Co. by applying the trapezoidal rule. Then, the ΔPS was determined by subtracting the time that corresponds to 25% of the area from the time that corresponds to 75% of the area.

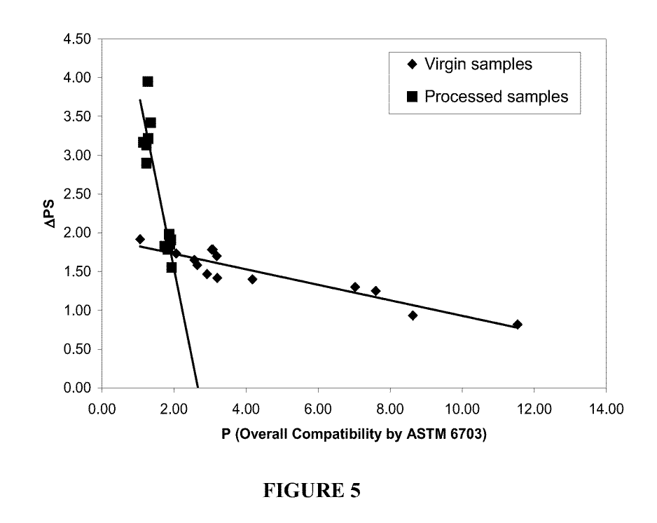

In parallel, the stability of each sample (P-value) was determined by ASTM 6703. In FIG. 5, the stability parameter ΔPS was plotted as a function of the standard stability parameter P value measured by ASTM 6703. As can be seen in FIG. 5, two different correlations were obtained corresponding to the two types of samples, i.e., virgin and processed materials, with correlation coefficients (R²) of 0.8637 and 0.7878, respectively. This indicates that there was a strong correlation between both independent measurements (ΔPS and P-value).

Accordingly, these results show that ΔPS is a parameter that measures stability of asphaltenes in a similar way to the standard P-value.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A method for determining asphaltene stability in a hydrocarbon-containing material having solvated asphaltenes therein, the method comprising the steps of:
(a) precipitating an amount of the asphaltenes from a liquid sample of the hydrocarbon containing material with at least one alkane mobile phase solvent in a column;
(b) dissolving a first amount the precipitated asphaltenes by gradually and continuously adding to the column a final mobile phase solvent having a solubility parameter at least about 1 MPa^{0.5} higher than the at least one alkane mobile phase solvent, wherein the alkane mobile phase solvent changes from the alkane mobile phase solvent to the final mobile phase solvent during a period of about 5 minutes to about 120 minutes at a flowrate of about 1 mL/min to about 4 mL/min;
(c) monitoring the concentration of each of the eluted fractions from the column;
(d) generating a curve that represents the solubility parameter distribution of the asphaltene in the hydrocarbon containing material; and
(e) determining one or more asphaltene stability parameters of the hydrocarbon containing material.

2. The method of claim 1, wherein the at least one alkane mobile phase solvent is selected from the group consisting of iso-octane, pentane, hexane, heptane and mixtures thereof.

3. The method of claim 1, wherein the first final mobile phase solvent is gradually and continuously added to the column at the injection point to sequentially change the alkane mobile phase solvent from 100% alkane mobile phase solvent to 100% final mobile phase solvent.

4. The method of claim 1, wherein the final mobile phase solvent is gradually and continuously added to the column at the injection point to sequentially change the alkane mobile phase solvent from 100% alkane mobile phase solvent to 100% final mobile phase solvent.

5. The method of claim 1, wherein the final mobile phase solvent is gradually and continuously added to the column at or upstream of the inlet of the column.

6. The method of claim 1, wherein the final mobile phase solvent is added to the column about 10 minutes after the liquid sample and alkane mobile phase are injected into the column.

7. The method of claim 1, further comprising monitoring the asphaltene concentration in the eluted fractions from the column after step (b) with a liquid chromatography detector which generates a signal proportional to the amount of each eluted fraction.

8. The method of claim 7, comprising calculating a percentage of each peak area for the first amount and the second amount of dissolved asphaltenes from the total peak areas, wherein the peak areas are derived from the signals.

9. A method for determining asphaltene stability in a hydrocarbon-containing material having solvated asphaltenes therein, the method comprising the steps of:
(a) precipitating an amount of the asphaltenes from a liquid sample of the hydrocarbon containing material with at least one alkane mobile phase solvent in a column;
(b) dissolving a first amount and a second amount of the precipitated asphaltenes by
(i) gradually and continuously adding to the column a first final mobile phase solvent having a solubility parameter at least about 1 MPa^{0.5} higher than the at least one alkane mobile phase solvent, at a rate of to dissolve a first amount of the precipitated asphaltenes; and
(ii) gradually and continuously adding to the column a second final mobile phase solvent having a solubility parameter at least about 1 MPa^{0.5} higher than the first final mobile phase solvent to dissolve a second amount of the precipitated asphaltenes
wherein the alkane mobile phase solvent changes from the alkane mobile phase solvent to the second final mobile phase solvent over a period of about 5 minutes to about 120 minutes at a flowrate of about 1 mL/min to about 4 mL/min.
(c) monitoring the concentration of each of the eluted fractions from the column;
(d) generating a curve that represents the solubility parameter distribution of the asphaltene in the hydrocarbon containing material; and
(e) determining one or more asphaltene stability parameters of the hydrocarbon containing material.

10. The method of claim 9, wherein the first final mobile phase solvent is gradually and continuously added to the column at the injection point to sequentially change the alkane mobile phase solvent from 100% alkane mobile phase solvent to 100% first final mobile phase solvent.

11. The method of claim 9, wherein the first final mobile phase solvent is gradually and continuously added to the column at the injection point to sequentially change the first final mobile phase solvent from 100% first final mobile phase solvent to 100% final mobile phase solvent.

12. The method of claim 9, wherein the alkane mobile phase solvent is n-heptane, the first final mobile phase solvent is a blend of 90% dichloromethane and 10% methanol and the second final mobile phase solvent is methanol.

13. The method of claim 9, wherein the first final mobile phase solvent is added to the column 10 minutes after the liquid sample of the hydrocarbon containing material and the at least one alkane mobile phase solvent are added to the column.

14. The method of claim 9, wherein the second mobile phase solvent is added to the column 20 minutes after the at least first final mobile phase solvent is added to the column.

15. The method of claim 9, wherein the step of determining one or more asphaltene stability parameters comprises calculating an average solubility parameter of the second amount of dissolved asphaltenes.

16. The method of claim 9, wherein the average solubility parameter of the second amount of dissolved asphaltenes is calculated as a mean of a distribution corresponding to a peak or shoulder of the second amount of dissolved asphaltenes derived from the solubility profile.

17. The method of claim 9, wherein the step of determining one or more asphaltene stability parameters comprises calculating a ratio of peak, areas of the second amount of dissolved asphaltenes to the first amount of dissolved asphaltenes, wherein each of the peak areas are derived from the solubility profile.

18. The method of claim 9, wherein the step of determining one or more asphaltene stability parameters comprises calculating the overlapping area of the peak areas of the second amount of dissolved asphaltenes and the first amount of dissolved asphaltenes.

19. The method of claim 9, wherein the step of determining one or more asphaltene stability parameters comprises calculating an average solubility parameter of the second amount of dissolved asphaltenes.

20. The method of claim 9, wherein the average solubility parameter of the second amount of dissolved asphaltenes is calculated as a mean of a distribution corresponding to a peak or shoulder of the second amount of dissolved asphaltenes derived from the solubility profile.

21. The method of claim 9, wherein the step of determining one or more asphaltene stability parameters comprises calculating an overlapping area of peak areas of the second amount of dissolved asphaltenes and the first amount of dissolved asphaltenes, wherein each of the peak areas are derived from the solubility profile.

22. The method of claim 9, wherein the step of determining one or more asphaltene stability parameters comprises calculating ΔPS from an equation:
ΔPS=t(75%)−t(25%)
wherein t(75%) and t(25%) represent the time at which 75% and 25% of the asphaltene in the hydrocarbon-containing material have eluted.

23. The method of claim 9, further comprising selecting a second hydrocarbon containing material; repeating steps (a)-(e); and comparing the results with the first hydrocarbon containing material.

24. A method for reducing fouling in one or more crude hydrocarbon refinery components, the method comprising the steps of:
(a) selecting one or more hydrocarbon-containing feedstocks having a stable plurality of asphaltene components therein, wherein the selection of the one or more hydrocarbon-containing feedstocks comprises:
(i) precipitating an amount of asphaltenes from a liquid sample of a hydrocarbon containing material with an alkane mobile phase solvent in a column;
(ii) dissolving a first amount the precipitated asphaltenes by gradually and continuously adding to the column a final mobile phase solvent having a solubility parameter at least about 1 MPa^{0.5} higher than the at least one alkane mobile phase solvent, wherein the alkane mobile phase solvent changes from the alkane mobile phase solvent to the final mobile phase solvent during a period of about 5 minutes to about 120 minutes at a flowrate of about 1 mL/min to about 4 mL/min;
(iii) monitoring the concentration of eluted fractions from the column;
(iv) generating a curve that represents the solubility parameter distribution of the asphaltene in the hydrocarbon containing material; and
(v) determining one or more asphaltene stability parameters of the hydrocarbon containing material; and
(b) feeding the selected one or more hydrocarbon-containing feedstocks to the one or more crude hydrocarbon refinery components.

25. The method of claim 24, wherein the one or more crude hydrocarbon refinery components are selected from the group consisting of a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, a storage tank and a visbreaker.

26. A system capable of experiencing fouling conditions associated with particulate or asphaltene fouling, the system comprising:
(a) one or more crude hydrocarbon refinery components; and
(b) one or more hydrocarbon-containing feedstocks having a stable plurality of asphaltene components therein and in fluid communication with the one or more crude hydrocarbon refinery components, wherein the one or more hydrocarbon-containing feedstocks are selected by a process comprising:
(i) precipitating an amount of asphaltenes from a liquid sample of a hydrocarbon containing material with an alkane mobile phase solvent in a column;
(ii) dissolving a first amount the precipitated asphaltenes by gradually and continuously adding to the column a final mobile phase solvent having a solubility parameter at least about 1 MPa^{0.5} higher than the at least one alkane mobile phase solvent, wherein the alkane mobile phase solvent changes from the alkane mobile phase solvent to the final mobile phase solvent during a period of about 5 minutes to about 120 minutes at a flowrate of about 1 mL/min to about 4 mL/min;
(iii) monitoring the concentration of eluted fractions from the column;
(iv) generating a curve that represents the solubility parameter distribution of the asphaltene in the hydrocarbon containing material; and
(v) determining one or more asphaltene stability parameters of the hydrocarbon containing material.

27. The system of claim 26, wherein the one or more crude hydrocarbon refinery components are selected from the group consisting of a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, a storage tank and a visbreaker.

28. A method for extending the activity of a supported or unsupported catalyst used in the reaction of one or more hydrocarbon-containing feedstocks, the method comprising the steps of:
(a) selecting one or more hydrocarbon-containing feedstocks having a stable plurality of asphaltene components therein, wherein the selection of the one or more hydrocarbon-containing feedstocks comprises:
(i) precipitating an amount of asphaltenes from a liquid sample of a hydrocarbon containing material with an alkane mobile phase solvent in a column;
(ii) dissolving a first amount the precipitated asphaltenes by gradually and continuously adding to the column a final mobile phase solvent having a solubility parameter at least about 1 MPa^{0.5} higher than the at least one alkane mobile phase solvent, wherein the alkane mobile phase solvent changes from the alkane mobile phase solvent to the final mobile phase solvent during a period of about 5 minutes to about 120 minutes at a flowrate of about 1 mL/min to about 4 mL/min;
(iii) monitoring the concentration of eluted fractions from tire column;
(iv) generating a curve that represents the solubility parameter distribution of the asphaltene in the hydrocarbon containing material; and
(v) determining one or more asphaltene stability parameters of the hydrocarbon containing material; and
(b) contacting the selected one or more hydrocarbon-containing feedstocks with a supported or unsupported catalyst at a reaction temperature in a reaction zone.

29. A method for determining asphaltene stability in a hydrocarbon-containing material having solvated asphaltenes therein, the method comprising the steps of:
(a) precipitating an amount of the asphaltenes from a liquid sample of the hydrocarbon containing material with an alkane mobile phase solvent in a column;
(b) dissolving a first amount the precipitated asphaltenes by gradually and continuously adding to the column a final mobile phase solvent having a solubility parameter at least about 1 MPa^{0.5} higher than the at least one alkane mobile phase solvent, wherein the alkane mobile phase solvent changes from the alkane mobile phase solvent to the final mobile phase solvent during a period of about 5 minutes to about 120 minutes at a flowrate of about 1 mL/min to about 4 mL/min;
(c) monitoring the concentration of eluted fractions from the column;
(d) generating a curve that represents the solubility parameter distribution of the asphaltene in the hydrocarbon containing material; and
(e) determining one or more asphaltene stability parameters of the hydrocarbon containing material by calculating ΔPS from an equation:
ΔPS=t(75%)−t(25%)
wherein t(75%) and t(25%) represent the time at which 75% and 25% of the asphaltene in the hydrocarbon-containing material have eluted.

30. A system, comprising:
a plurality of components; and
a processing device comprising at least one hardware processor, wherein the processing device is configured to operate the plurality of components to cause:
(a) an amount of the asphaltenes to be precipitated from a liquid sample of the hydrocarbon containing material with at least one alkane mobile phase solvent in a column;
(b) a first amount the precipitated asphaltenes to be dissolved by gradually and continuously adding to the column a final mobile phase solvent having a solubility parameter at least about 1 MPa^{0.5} higher than the at least one alkane mobile phase solvent, wherein the alkane mobile phase solvent changes from the alkane mobile phase solvent to the final mobile phase solvent during a period of about 5 minutes to about 120 minutes at a flowrate of about 1 mL/min to about 4 mL/min;
(c) a concentration of each of the eluted fractions from the column to be monitired;
(d) a curve that represents the solubility parameter distribution of the asphaltene in the hydrocarbon containing material to be generated; and
(e) one or more asphaltene stability parameters of the hydrocarbon containing material to be determined.
